(19) United States
(12) Patent Application Publication
(10) Pub. No.: US 2026/0371280 A1
(43) Pub. Date: Nov. 19, 2026

(54) METHOD AND DEVICE FOR WIRELESS COMMUNICATION USING NETWORK SLICE

(71) Applicant: Samsung Electronics Co., Ltd., Suwon-si, Gyeonggi-do (KR)

(72) Inventor: Kyungjoo SUH, Suwon-si (KR)

(21) Appl. No.: 19/156,567

(22) PCT Filed: Feb. 15, 2024
(86) PCT No.: PCT/KR2024/095232

§ 371 Date: Aug. 14, 2025

(30) Foreign Application Priority Data
Feb. 17, 2023 (KR) 10-2023-0021645

(51) Int. Cl. H04W 60/00; H04W 48/08; H04W 48/18

(52) U.S. Cl. CPC H04W 60/002; H04W 48/08; H04W 48/18

(57) ABSTRACT

The present disclosure relates to a 5G or 6G communication system for supporting higher data transmission rates. A method and a device for wireless communication are provided. A method by which a user equipment (UE) performs wireless communication comprises the steps of: transmitting a registration request message to an access and mobility function (AMF), the registration request message including information indicating whether the UE has a function capable of notifying whether pending network slice selection assistance information (NSSAI) is used in relation to slice authentication or slice subscription; and receiving a registration accept message from the AMF as a response to the registration request message.

### TECHNICAL FIELD

The disclosure relates to wireless communication. More specifically, the disclosure relates to a method and device for wireless communication using a network slice.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the development of 5G communication systems, network slice (or network slicing) technology has been introduced for radio access network (RAN) and core network (CN) structures.

A UE may be supported by a network in a specific area, and may use a slice that is authenticated to be used by the UE. A slice authentication procedure may be performed when the UE requests the slice. A result of the slice authentication may be either success or failure. The UE may request a slice based on slice information stored in the UE, and the network may determine, based on information on the UE held in the network, whether to accept the request of the UE. Therefore, if there is a mismatch between the slice information stored in the UE and the information on the UE held in the network, a malfunction may occur for the request.

### DETAILED DESCRIPTION OF THE INVENTION

### Technical Problem

The disclosure is to provide a method and device for enabling a terminal and network entities to more efficiently process information on a network slice in communication using a network slice.

### Technical Solution

According to an embodiment of the disclosure, a method for wireless communication by a user equipment (UE) is provided. The method includes: transmitting a registration request message to an access and mobility function (AMF), wherein the registration request message includes information indicating whether the UE has a function capable of notifying whether the UE uses pending network slice selection assistance information (NSSAI) in relation to slice authentication or slice subscription; and receiving a registration accept message from the AMF in response to the registration request message.

According to an embodiment of the disclosure, a method for wireless communication by an access and mobility function (AMF) is provided. The method includes: receiving a registration request message from a user equipment (UE), wherein the registration request message includes information indicating whether the UE has a function capable of notifying whether the UE uses pending network slice selection assistance information (NSSAI) in relation to slice authentication or slice subscription; and transmitting a registration accept message to the UE in response to the registration request message.

According to an embodiment of the disclosure, a user equipment (UE) for wireless communication is provided. The UE includes a transceiver, and at least one processor connected to the transceiver. The at least one processor is configured to: transmit a registration request message to an access and mobility function (AMF), wherein the registration request message includes information indicating whether the UE has a function capable of notifying whether the UE uses pending network slice selection assistance information (NSSAI) in relation to slice authentication or slice subscription; and receive a registration accept message from the AMF in response to the registration request message.

According to an embodiment of the disclosure, a device for an access and mobility function (AMF) is provided. The device includes a transceiver, and at least one processor connected to the transceiver. The at least one processor is configured to: receive a registration request message from a user equipment (UE), wherein the registration request message includes information indicating whether the UE has a function capable of notifying whether the UE uses pending network slice selection assistance information (NSSAI) in relation to slice authentication or slice subscription; and transmit a registration accept message to the UE in response to the registration request message.

### Advantageous Effects

According to the disclosure, a method and device for enabling a terminal and network entities to more efficiently process information on a network slice can be provided.

### BRIEF DESCRIPTION OF DRAWINGS

FIG. 1 illustrates an example of a 5G network environment according to an embodiment of the disclosure;

FIG. 2 is a flowchart illustrating communication between a UE and network entities according to an embodiment of the disclosure;

FIG. 3 is a flowchart illustrating communication between the UE and the network entities according to an embodiment of the disclosure;

FIG. 4 is a flowchart illustrating communication between the UE and the network entities according to an embodiment of the disclosure; and

FIG. 5 is a flowchart illustrating communication between the UE and the network entities according to an embodiment of the disclosure.

FIG. 6 illustrates a structure of a UE according to an embodiment of the disclosure.

FIG. 7 illustrates a structure of a network entity according to an embodiment of the disclosure.

### MODE FOR CARRYING OUT THE INVENTION

Hereinafter, embodiments of the disclosure will be described with reference to the accompanying drawings. In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description of the disclosure, terms and names defined in the 3rd generation partnership project long term evolution (3GPP LTE) or 3GPP NR standards or terms and names modified based thereon will be used for the sake of descriptive convenience. However, the disclosure is not limited by the above terms and names, and may be applied in the same way to systems that conform other standards. In the disclosure, a base station is an entity that allocates resources to a user equipment (UE), and may be at least one of a gNode B, a gNB, an eNode B, an eNB, a Node B, a BS, a next-generation RAN (NG-RAN), a base station controller, or a node on a network. The base station may provide network access to a UE(s) in the LTE system or NR system. In the disclosure, the term “eNB” may be interchangeably used with the term “gNB” for the sake of descriptive convenience. That is, a base station described as “eNB” may refer to “gNB”. In the disclosure, the term “terminal” may refer to not only mobile phones, NB-IoT devices, and sensors, but also various wireless communication devices.

That is, the following detailed description of embodiments of the disclosure is directed to communication standards specified by 3GPP, but based on determinations by those skilled in the art, the main idea of the disclosure may also be applied to other communication systems having similar technical backgrounds through some modifications without significantly departing from the scope of the disclosure.

In a 5G or NR system, an access and mobility function (AMF) that is a management entity for managing mobility of a UE, and a session management function (SMF) that is an entity for managing a session are separated. Accordingly, unlike a 4G LTE communication system in which a mobility management entity (MME) performs both mobility management and session management, entities that perform mobility management and session management are separated into an AMF and an SMF, respectively, in the 5G or NR system, so that a communication method and a communication management method between a UE and a network entity have changed.

In the 5G or NR system, for non-3GPP access, through a non-3GPP inter-working function (N3IWF), mobility management is performed via an AMF and session management is performed via an SMF. In addition, security-related information that is an important element in mobility management is also processed via the AMF.

As described above, in the 4G LTE system, an MME is responsible for both mobility management and session management. In the 5G or NR system, a non-standalone (NSA) architecture, in which communication is performed also using network entities of the 4G LTE system, may be supported.

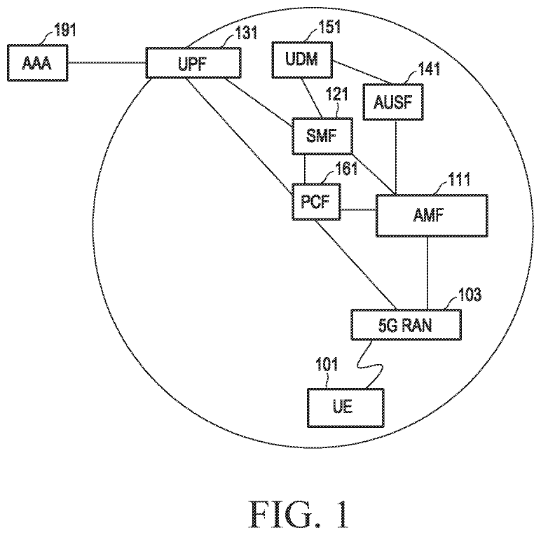

FIG. 1 illustrates an example of a 5G network environment according to an embodiment of the disclosure.

Referring to FIG. 1, a 5G or NR core network may be configured to include at least one of network functions (NFs), such as a user plane function (UPF) 131, a session management function (SMF) 121, an access and mobility management function (AMF) 111, a 5G radio access network (RAN) 103, a user data management (UDM) 151, and a policy control function (PCF) 161. In addition, for authentication of these entities, entities, such as an authentication server function (AUSF) 141 and an authentication, authorization, and accounting (AAA) 171 may be included.

The AMF 111 is an entity for managing access and mobility of a user equipment (UE) 101. For example, AMF 111 may perform network functions, such as registration, connection, reachability, mobility management, access verification, authentication, and mobility event generation of UE 101.

The SMF 121 may perform management functions for a protocol data unit (PDU) session of the UE 101. For example, the SMF 121 may perform a session management function via session establishment, modification, and release and tunnel maintenance between the UPF 131 and the RAN 103 required therefor, a function for assigning and managing an Internet protocol (IP) address of the UE 101, and network functions, such as user plane selection and control, and traffic processing control and charging data collection control at the UPF 131.

The UPF 131 may serve to process data of the UE 101, and serve to perform data processing so that data transmitted by the UE 101 may be transferred to an external network or data introduced from an external network may be transmitted to the UE 101. For example, the UPF 131 may perform network functions, such as serving as an anchor between radio access technologies (RATs), packet routing and forwarding, packet inspection, user plane policy application, traffic use report generation, and buffering.

The UDM 151 may perform functions, such as generating authentication information for 3GPP security, user identifier (ID) processing, managing a list of network functions (NFs) supporting the UE 101, and subscription information management.

The PCF 161 is an NF that manages operator policy information for providing services in the 5G system.

The user equipment (UE or terminal) may access a 5G core network through the base station (BS or 5G radio access network (RAN)) 103. An N3 inter-working function (N3IWF) may exist for a case where the UE communicates via non-3GPP access. When communication is performed via non-3GPP access, session management may be controlled at the UE, non-3GPP access, N3IWF, and SMF, and for mobility management, control may be performed via the UE, non-3GPP access, N3IWF, and AMF.

In the 5G or NR system, entities that perform mobility management and session management are separated into the AMF 111 and the SMF 121. For the 5G or NR system, a standalone (SA) deployment structure, in which communication is performed only by 5G or NR entities, and a non-standalone (NSA) deployment structure, in which both 4G entities and 5G or NR entities are used, are considered.

As shown in FIG. 1, when the UE communicates with the network, control is performed by the eNB, and a type of deployment in which 5G entities of the core network is used may be possible. In this case, mobility management between the UE and the AMF, and session management between the UE and the SMF may be performed in a non-access stratum (NAS) layer that is layer 3.

In the disclosure, a 5G or 4G (long-term evolution (LTE)) communication network is assumed, but the concept of the disclosure is applicable to other communication systems within a scope understandable by a person skilled in the art.

3GPP standards standardize the 5G network system architecture and procedures. Mobile communication operators may provide various services on 5G networks. In order to provide each service, mobile communication operators need to satisfy different service requirements (e.g., a delay time, a communication range, a data rate, a bandwidth, reliability, etc.) for each service. To this end, mobile communication operators may configure network slices and allocate network resources suitable for specific services by network slice or by network slice set. The network resources may refer to network functions (NFs), logical resources provided by NFs, radio resources allocated by a base station, or the like.

For example, a mobile communication operator may configure network slice A to provide mobile broadband services, network slice B to provide vehicle communication services, and network slice C to provide IoT services. That is, in this way, a 5G network may efficiently provide a corresponding service to a UE via network slices specialized for characteristics of each service.

A UE may be supported by a network in a specific area, and may use a slice that is authenticated to be used by the UE. A slice authentication procedure may be performed when the UE requests the slice. A result of the slice authentication may be either success or failure. The UE may request a slice based on slice information stored in the UE, and the network may determine, based on information on the UE held in the network, whether to accept the request of the UE. Therefore, if there is a mismatch between the slice information stored in the UE and the information on the UE held in the network, a malfunction may occur for the request.

Depending on a network slice used by the UE, only a user (i.e., UE) who has been authenticated and authorized via network slice-specific authentication and authorization (NSSAA) may use the slice.

The UE may simultaneously register with one or more pieces of single-network slice selection assistance information (S-NSSAI), i.e., slices, but the registered slices should belong to the same network slice simultaneous registration group (NSSRG). NSSRG information may provide subscription-based restrictions on simultaneous registration of network slices. That is, the NSSRG information enables the UE to control network slices available for simultaneous registration.

If the UE is still in the middle of authentication and authorization while performing NSSAA, information may be transferred to the UE via a pending NSSAI information element (IE).

The disclosure relates to problems occurring when a UE attempts to simultaneously register with multiple network slices. That is, for simultaneous registration with multiple network slices, the multiple network slices should be registered in the same NSSRG. In addition, even when the network provides allowed NSSAI indicating slices allowed to a UE, the allowed slices should belong to the same NSSRG.

However, in a case of pending NSSAI for which the UE is proceeding with slice authentication, it is unknown whether authentication is normally performed so that a corresponding slice will later become allowed NSSAI, or whether the slice become rejected NSSAI. Therefore, a method for processing pending NSSAI is required in an NSSRG procedure for a UE to simultaneously register with multiple slices.

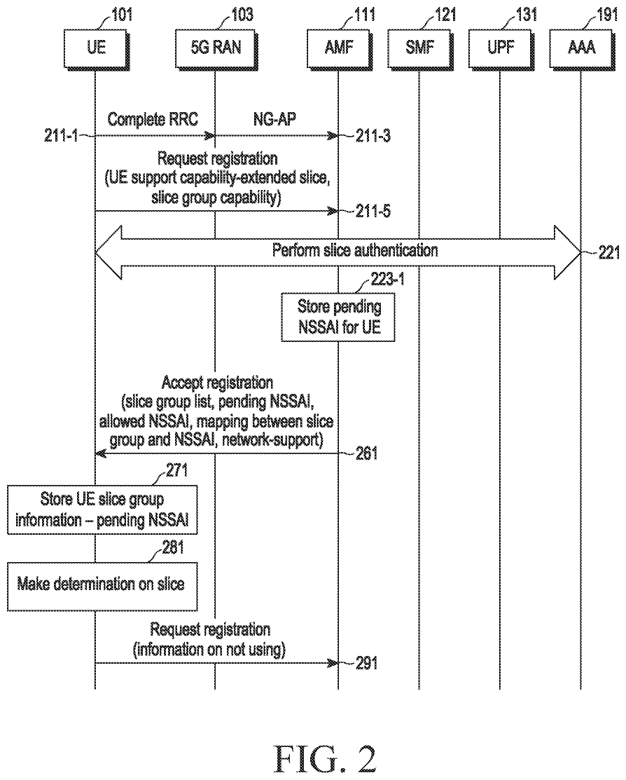

FIG. 2 is a flowchart illustrating communication between the UE and the network entities according to an embodiment of the disclosure.

In operation 211-1, the UE transmits a radio resource control (RRC) complete message to the 5G radio access network (RAN) (e.g., base station).

In operation 211-3, the 5G RAN transmits a next generation-application protocol (NG-AP) message to the AMF.

In operation 211-5, the UE transmits a registration request message to the AMF. The UE may indicate that the UE supports an NSSAA procedure, by using a parameter referred to as “NSSAA supported” in a UE 5G mobility management (5GMM) core network capability information element within the registration request message.

The registration request message may include information for indicating to the AMF whether the UE has a capability to support multiple functions for slices. For example, the UE may indicate whether the UE is able to support slices with different slice group information.

The registration request message may further include a slice aware capability information element. This may be used to indicate whether the UE has a capability to inform the network whether the UE uses or no longer uses pending NSSAI in relation to slice authentication and/or slice subscription, or may be used to indicate a type (e.g., version) of the UE (i.e., terminal). The network may identify, based on the type of the UE, whether the UE has a capability of processing pending NSSAI of 3GPP release 18, etc.

The registration request message may further include information for signaling, to the network, an occurrence of a change in slice information stored in the UE when the change has occurred. For example, the registration request message may include information for indicating that the UE will no longer use pending NSSAI stored in the UE.

The registration request message may include information indicating whether the UE supports a function capable of requesting, as request NSSAI from the network, slices that do not belong to the same slice subscription group. The information may be transmitted to the network via an information element of an extended-slice-extended slice group capability.

The UE may, separately from operation 211-5, perform signaling to the network when a change occurs in the slice information. For example, a slice information change notify message may be used for the signaling.

In operation 221, the UE and the AAA perform a slice authentication. The AUSF, the AAA, and the AMF may be involved in this NSSAA authentication.

In operation 223-1, the AMF stores pending NSSAI for the UE. The pending NSSAI indicates NSSAI for which a slice authentication/authorization procedure is being performed for the UE. The AMF may use the stored pending NSSAI to indicate that the slice authentication/authorization procedure is in progress for a corresponding slice when the AMF transmits a registration accept message to the UE.

In operation 261, the AMF transmits the registration accept message to the UE. The registration accept message may include information on the pending NSSAI.

The registration accept message may include at least some of the following information.
Slice group list: A slice group list is information indicating at least one slice group from which the UE may receive a service based on subscription. The UE may register simultaneously with multiple pieces of S-NSSAI belonging to the same subscribed slice group.
Slice group-related pending NSSAI information: Pending NSSAI information may be transmitted along with subscribed slice group information.
Mapping information between a slice group and NSSAI: Information indicating a slice group, to which each of at least one piece of NSSAI belongs, by mapping subscribed NSSAI group information and NSSAI information (for example, mapping information between pending NSSAI and a slice subscription group, mapping information between allowed NSSAI and a slice subscription group, and mapping information between configured NSSSAI and a slice subscription group).
Indicator indicating whether the network supports a function related to multiple slice groups: This may indicate that the network supports multiple slice groups for a specific slice (i.e., a single slice belongs to multiple slice groups), or that the network supports a function of allowing the UE to simultaneously register for slices belonging to different slice groups.
Allowed NSSAI: indicates NSSAI that is allowed by the network for the UE to access. According to an embodiment, when the AMF receives, from the UE, information (e.g., information element) indicating that the UE will no longer use pending NSSAI, the AMF may select allowed NSSAI from among configured NSSAI and transmit the allowed NSSAI to the UE.
Pending NSSAI: If slice-specific authentication/authorization for the UE is not completed, the AMF may inform the UE of information on a corresponding slice as pending NSSAI. Along with the pending NSSAI, the AMF may transmit, to the UE via an additional indicator or bit, information indicating whether an NSSRG, that is, a subscribed slice group that the UE is to register with, is supported even if information on a subscribed slice group to which the pending NSSAU belongs is different.
Recommended NSSAI and subscribed slice group: The registration accept message may include information indicating a supportable subscribed slice group and recommended NSSAI along with pending NSSAI information. The recommended NSSAI may be NSSAI that has undergone an authentication and authorization procedure within the subscribed slice group.
Information indicating whether the network supports an extended slice function: An extended slice function refers to a function that supports simultaneous or non-simultaneous UE registration for slices belonging to different subscribed slice groups, i.e., NSSRGs.

In operation 271, the UE stores information received via the registration accept message (e.g., a slice group list, allowed NSSAI, pending NSSAI, etc.).

In operation 281, the UE determines whether to use the pending NSSAI. That is, the UE determines whether to use the pending NSSAI or not in a subsequent registration procedure.

In operation 291, the UE transmits a registration request message to the AMF. The registration request message may include information indicating whether the UE is to use the pending NSSAI or information indicating that the UE will no longer use the pending NSSAI.

Upon reception, from the UE, the registration request message including information indicating that the pending NSSAI is not used, the AMF may perform the following operations.
The AMF may process (e.g., terminate) slice authentication related to the UE based on information received from the UE. That is, if there is an ongoing slice authentication/authorization procedure, the AMF may terminate the procedure.
The AMF may, based on information received from the UE, select allowed NSSAI or configured NSSAI, except for information on pending NSSAI indicated as not to be used by the UE, when the AMF selects allowed NSSAI or configured NSSAI information to be subsequently transmitted to the UE.

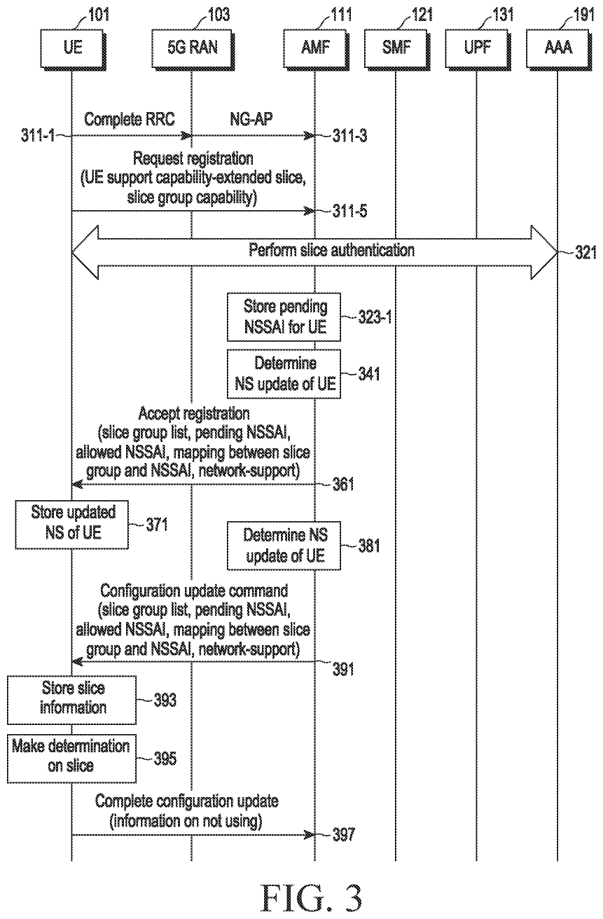

FIG. 3 is a flowchart illustrating communication between the UE and the network entities according to an embodiment of the disclosure.

In operation 311-1, the UE transmits an RRC complete message to the 5G RAN.

In operation 311-3, the 5G RAN transmits an NG-AP message to the AMF.

In operation 311-5, the UE transmits a registration request message to the AMF.

The UE may indicate that the UE supports an NSSAA procedure, by using a parameter referred to as “NSSAA supported” in a UE 5G mobility management (5GMM) core network capability information element within the registration request message.

The registration request message may include information for indicating to the AMF whether the UE has a capability to support multiple functions for slices. For example, the UE may indicate whether the UE is able to support slices with different slice group information.

The registration request message may further include a slice aware capability information element. This may be used to indicate whether the UE has a capability to inform the network whether the UE uses or no longer uses pending NSSAI in relation to slice authentication and slice subscription, or may be used to indicate a type (e.g., version) of the UE (i.e., terminal). The network may identify, based on the type of the UE, whether the UE has a capability of processing pending NSSAI of 3GPP release 18, etc.

The registration request message may further include information for signaling, to the network, an occurrence of a change in slice information stored in the UE when the change has occurred. For example, the registration request message may include information for indicating that the UE will no longer use pending NSSAI stored in the UE.

The registration request message may include information indicating whether the UE supports a function capable of requesting, as request NSSAI from the network, slices that do not belong to the same slice subscription group. The information may be transmitted to the network via an information element of an extended-slice-extended slice group capability.

The UE may, separately from operation 311-5, perform signaling to the network when a change occurs in the slice information. For example, a slice information change notify message may be used for the signaling.

In operation 321, the UE and the AAA perform a slice authentication. The AUSF, the AAA, and the AMF may be involved in this NSSAA authentication.

In operation 323-1, the AMF stores pending NSSAI for the UE. The pending NSSAI indicates NSSAI for which a slice authentication/authorization procedure is being performed for the UE. The AMF may use the stored pending NSSAI to indicate that the slice authentication/authorization procedure is in progress for a corresponding slice when the AMF transmits a registration accept message to the UE.

In operation 341, the AMF determines, for UEs managed by the AMF, whether to update information related to the network slice of the UE when the information has changed. When the AMF determines to update the information, the AMF notifies the UE of the update via subsequent operation 361.

In operation 361, the AMF transmits a registration accept message to the UE. The registration accept message may include information on the pending NSSAI.

The registration accept message may include at least some of the following information.
Slice group list: A slice group list is information indicating at least one slice group from which the UE may receive a service based on subscription. The UE may register simultaneously with multiple pieces of S-NSSAI belonging to the same subscribed slice group.
Slice group-related pending NSSAI information: Pending NSSAI information may be transmitted along with subscribed slice group information.
Mapping information between a slice group and NSSAI: Information indicating a slice group, to which each of at least one piece of NSSAI belongs, by mapping subscribed NSSAI group information and NSSAI information (for example, mapping information between pending NSSAI and a slice subscription group, mapping information between allowed NSSAI and a slice subscription group, and mapping information between configured NSSSAI and a slice subscription group).
Indicator indicating whether the network supports a function related to multiple slice groups: This may indicate that the network supports multiple slice groups for a specific slice (i.e., a single slice belongs to multiple slice groups), or that the network supports a function of allowing the UE to simultaneously register for slices belonging to different slice groups.
Allowed NSSAI: indicates NSSAI that is allowed by the network for the UE to access. According to an embodiment, when the AMF receives, from the UE, information (e.g., information element) indicating that the UE will no longer use pending NSSAI, the AMF may select allowed NSSAI from among configured NSSAI and transmit the allowed NSSAI to the UE.
Pending NSSAI: If slice-specific authentication/authorization for the UE is not completed, the AMF may inform the UE of information on a corresponding slice as pending NSSAI. Along with the pending NSSAI, the AMF may transmit, to the UE via an additional indicator or bit, information indicating whether an NSSRG, that is, a subscribed slice group that the UE is to register with, is supported even if information on a subscribed slice group to which the pending NSSAU belongs is different.
Recommended NSSAI and subscribed slice group: The registration accept message may include information indicating a supportable subscribed slice group and recommended NSSAI along with pending NSSAI information. The recommended NSSAI may be NSSAI that has undergone an authentication and authorization procedure within the subscribed slice group.
Information indicating whether the network supports an extended slice function: An extended slice function refers to a function that supports simultaneous or non-simultaneous UE registration for slices belonging to different subscribed slice groups, i.e., NSSRGs.

In operation 371, the UE stores information received via the registration accept message (e.g., a slice group list, allowed NSSAI, pending NSSAI, etc.).

In operation 381, the AMF determines, for the UEs managed by the AMF, whether to update information related to the network slice of the UE when the information has changed. When the AMF determines to update the information, the AMF notifies the UE of the update via subsequent operation 391.

In operation 391, in response to the determination to update the information related to the network slice of the UE, the AMF transmits a configuration update command message to the UE. The configuration update command message may include information on the pending NSSAI.

The configuration update command message may include at least some of the following information.
Slice group list: A slice group list is information indicating at least one slice group from which the UE may receive a service based on subscription. The UE may register simultaneously with multiple pieces of S-NSSAI belonging to the same subscribed slice group.
Slice group-related pending NSSAI information: Pending NSSAI information may be transmitted along with subscribed slice group information.
Mapping information between a slice group and NSSAI: Information indicating a slice group, to which each of at least one piece of NSSAI belongs, by mapping subscribed NSSAI group information and NSSAI information (for example, mapping information between pending NSSAI and a slice subscription group, mapping information between allowed NSSAI and a slice subscription group, and mapping information between configured NSSSAI and a slice subscription group).
Indicator indicating whether the network supports a function related to multiple slice groups: This may indicate that the network supports multiple slice groups for a specific slice (i.e., a single slice belongs to multiple slice groups), or that the network supports a function of allowing the UE to simultaneously register for slices belonging to different slice groups.
Allowed NSSAI: indicates NSSAI that is allowed by the network for the UE to access. According to an embodiment, when the AMF receives, from the UE, information (e.g., information element) indicating that the UE will no longer use pending NSSAI, the AMF may select allowed NSSAI from among configured NSSAI and transmit the allowed NSSAI to the UE.
Pending NSSAI: If slice-specific authentication/authorization for the UE is not completed, the AMF may inform the UE of information on a corresponding slice as pending NSSAI. Along with the pending NSSAI, the AMF may transmit, to the UE via an additional indicator or bit, information indicating whether an NSSRG, that is, a subscribed slice group that the UE is to register with, is supported even if information on a subscribed slice group to which the pending NSSAU belongs is different.
Recommended NSSAI and subscribed slice group: The registration accept message may include information indicating a supportable subscribed slice group and recommended NSSAI along with pending NSSAI information. The recommended NSSAI may be NSSAI that has undergone an authentication and authorization procedure within the subscribed slice group.
Information indicating whether the network supports an extended slice function: An extended slice function refers to a function that supports simultaneous or non-simultaneous UE registration for slices belonging to different subscribed slice groups, i.e., NSSRGs.

In operation 393, the UE stores information received via the configuration update command message (e.g., a slice group list, allowed NSSAI, pending NSSAI, etc.).

In operation 395, the UE determines whether to use the pending NSSAI. That is, the UE determines whether to use the pending NSSAI or not in a subsequent registration procedure.

In operation 397, the UE transmits a configuration update complete message to the AMF. The configuration update complete message may include information indicating whether the UE is to use the pending NSSAI or information indicating that the UE will no longer use the pending NSSAI.

Upon reception, from the UE, the configuration update complete message including information indicating that the pending NSSAI is not used, the AMF may perform the following operations.
The AMF may process (e.g., terminate) slice authentication related to the UE based on information received from the UE. That is, if there is an ongoing slice authentication/authorization procedure, the AMF may terminate the procedure.
The AMF may, based on information received from the UE, select allowed NSSAI or configured NSSAI, except for information on pending NSSAI indicated as not to be used by the UE, when the AMF selects allowed NSSAI or configured NSSAI information to be subsequently transmitted to the UE.

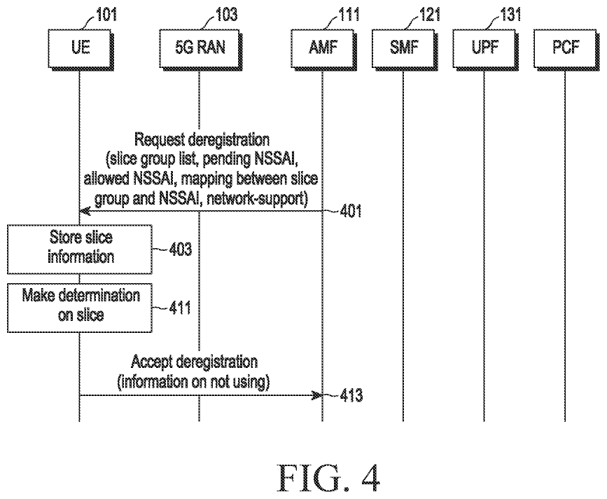

FIG. 4 is a flowchart illustrating communication between the UE and the network entities according to an embodiment of the disclosure.

In operation 401, the AMF transmits a deregistration request message to the UE.

The deregistration request message may include at least some of the following information.
Slice group list: A slice group list is information indicating at least one slice group from which the UE may receive a service based on subscription. The UE may register simultaneously with multiple pieces of S-NSSAI belonging to the same subscribed slice group.
Slice group-related pending NSSAI information: Pending NSSAI information may be transmitted along with subscribed slice group information.
Mapping information between a slice group and NSSAI: Information indicating a slice group, to which each of at least one piece of NSSAI belongs, by mapping subscribed NSSAI group information and NSSAI information (for example, mapping information between pending NSSAI and a slice subscription group, mapping information between allowed NSSAI and a slice subscription group, and mapping information between configured NSSSAI and a slice subscription group).
Indicator indicating whether the network supports a function related to multiple slice groups: This may indicate that the network supports multiple slice groups for a specific slice (i.e., a single slice belongs to multiple slice groups), or that the network supports a function of allowing the UE to simultaneously register for slices belonging to different slice groups.
Allowed NSSAI: indicates NSSAI that is allowed by the network for the UE to access. According to an embodiment, when the AMF receives, from the UE, information (e.g., information element) indicating that the UE will no longer use pending NSSAI, the AMF may select allowed NSSAI from among configured NSSAI and transmit the allowed NSSAI to the UE.
Pending NSSAI: If slice-specific authentication/authorization for the UE is not completed, the AMF may inform the UE of information on a corresponding slice as pending NSSAI. Along with the pending NSSAI, the AMF may transmit, to the UE via an additional indicator or bit, information indicating whether an NSSRG, that is, a subscribed slice group that the UE is to register with, is supported even if information on a subscribed slice group to which the pending NSSAU belongs is different.
Recommended NSSAI and subscribed slice group: The registration accept message may include information indicating a supportable subscribed slice group and recommended NSSAI along with pending NSSAI information. The recommended NSSAI may be NSSAI that has undergone an authentication and authorization procedure within the subscribed slice group.
Information indicating whether the network supports an extended slice function: An extended slice function refers to a function that supports simultaneous or non-simultaneous UE registration for slices belonging to different subscribed slice groups, i.e., NSSRGs.

In operation 403, the UE stores information received via the deregistration request message (e.g., a slice group list, allowed NSSAI, pending NSSAI, etc.).

In operation 411, the UE determines whether to use the pending NSSAI. That is, the UE determines whether to use the pending NSSAI or not in a subsequent registration procedure.

In operation 413, the UE transmits a deregistration accept message to the AMF. The deregistration accept message may include information indicating whether the UE is to use the pending NSSAI or information indicating that the UE will no longer use the pending NSSAI.

Upon reception, from the UE, the deregistration accept message including information indicating that the pending NSSAI is not used, the AMF may perform the following operations.
The AMF may process (e.g., terminate) slice authentication related to the UE based on information received from the UE. That is, if there is an ongoing slice authentication/authorization procedure, the AMF may terminate the procedure.
The AMF may, based on information received from the UE, select allowed NSSAI or configured NSSAI, except for information on pending NSSAI indicated as not to be used by the UE, when the AMF selects allowed NSSAI or configured NSSAI information to be subsequently transmitted to the UE.

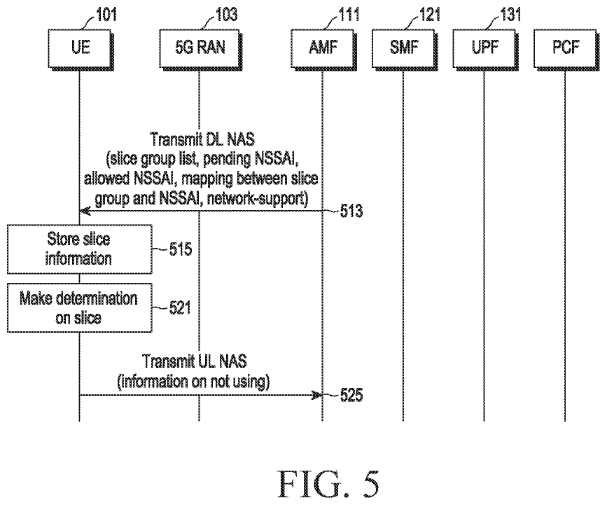

FIG. 5 is a flowchart illustrating communication between the UE and the network entities according to an embodiment of the disclosure.

In operation 513, the AMF may transmit a downlink (DL) non-access stratum (NAS) transport message to the UE.

The DL NAS transport message may include at least some of the following information.
Slice group list: A slice group list is information indicating at least one slice group from which the UE may receive a service based on subscription. The UE may register simultaneously with multiple pieces of S-NSSAI belonging to the same subscribed slice group.
Slice group-related pending NSSAI information: Pending NSSAI information may be transmitted along with subscribed slice group information.
Mapping information between a slice group and NSSAI: Information indicating a slice group, to which each of at least one piece of NSSAI belongs, by mapping subscribed NSSAI group information and NSSAI information (for example, mapping information between pending NSSAI and a slice subscription group, mapping information between allowed NSSAI and a slice subscription group, and mapping information between configured NSSSAI and a slice subscription group).
Indicator indicating whether the network supports a function related to multiple slice groups: This may indicate that the network supports multiple slice groups for a specific slice (i.e., a single slice belongs to multiple slice groups), or that the network supports a function of allowing the UE to simultaneously register for slices belonging to different slice groups.
Allowed NSSAI: indicates NSSAI that is allowed by the network for the UE to access. According to an embodiment, when the AMF receives, from the UE, information (e.g., information element) indicating that the UE will no longer use pending NSSAI, the AMF may select allowed NSSAI from among configured NSSAI and transmit the allowed NSSAI to the UE.
Pending NSSAI: If slice-specific authentication/authorization for the UE is not completed, the AMF may inform the UE of information on a corresponding slice as pending NSSAI. Along with the pending NSSAI, the AMF may transmit, to the UE via an additional indicator or bit, information indicating whether an NSSRG, that is, a subscribed slice group that the UE is to register with, is supported even if information on a subscribed slice group to which the pending NSSAU belongs is different.
Recommended NSSAI and subscribed slice group: The registration accept message may include information indicating a supportable subscribed slice group and recommended NSSAI along with pending NSSAI information. The recommended NSSAI may be NSSAI that has undergone an authentication and authorization procedure within the subscribed slice group.
Information indicating whether the network supports an extended slice function: An extended slice function refers to a function that supports simultaneous or non-simultaneous UE registration for slices belonging to different subscribed slice groups, i.e., NSSRGs.

In operation 515, the UE stores information received via the DL NAS transport message (e.g., a slice group list, allowed NSSAI, pending NSSAI, etc.).

In operation 521, the UE determines whether to use the pending NSSAI. That is, the UE determines whether to use the pending NSSAI or not in a subsequent registration procedure.

In operation 525, the UE transmits an uplink (UL) NAS transport message to the AMF. The UL NAS transport message may include information indicating whether the UE is to use the pending NSSAI or information indicating that the UE will no longer use the pending NSSAI.

Upon reception, from the UE, the UL NAS transport message including information indicating that the pending NSSAI is not used, the AMF may perform the following operations.
The AMF may process (e.g., terminate) slice authentication related to the UE based on information received from the UE. That is, if there is an ongoing slice authentication/authorization procedure, the AMF may terminate the procedure.
The AMF may, based on information received from the UE, select allowed NSSAI or configured NSSAI, except for information on pending NSSAI indicated as not to be used by the UE, when the AMF selects allowed NSSAI or configured NSSAI information to be subsequently transmitted to the UE.

The embodiments described via FIGS. 2 to 5 may be combined and executed. For example, after the operations described in FIG. 2 are executed, or while the operations are being executed, the operations described in FIGS. 3 to 5 may be executed. The execution of the operations described in any one of FIGS. 2 to 5 do not exclude the execution of the operations in the other drawings.

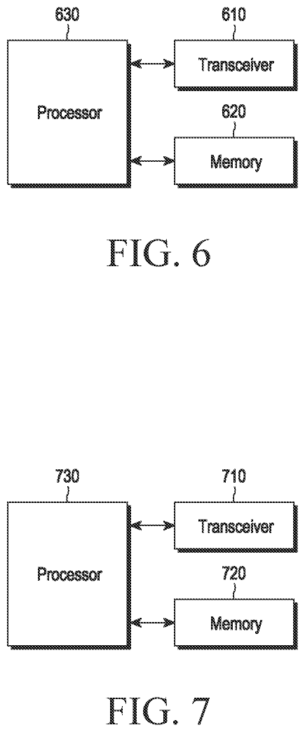

FIG. 6 illustrates a structure of a UE according to an embodiment of the disclosure.

As illustrated in FIG. 6, the UE of the disclosure may include a transceiver 610, memory 620, and a processor 630. The processor 630, the transceiver 610, and the memory 620 of the UE may operate according to the above-described operations of the UE. However, components of the UE are not limited to the above-described example. For example, the UE may include a larger or smaller number of components than the above-described components. In addition, the processor 630, the transceiver 610, and the memory 620 may be implemented in the form of a single chip.

The transceiver 610 refers to a UE receiver and a UE transmitter as a whole, and may transmit/receive signals with base stations or network entities. The signals transmitted/received with the base stations may include control information and data. To this end, the transceiver 610 may include an RF transmitter configured to up-convert and amplify the frequency of transmitted signals, an RF receiver configured to low-noise-amplify received signals and down-convert the frequency thereof, and the like. However, this is only an embodiment of the transceiver 610, and the components of the transceiver 610 are not limited to the RF transmitter and the RF receiver.

Also, the transceiver 610 may include wired/wireless transceivers, and may include various components for transmitting/receiving signals.

In addition, the transceiver 610 may receive signals through a radio channel, output the same to the processor 630, and transmit signals output from the processor 630 through the radio channel.

Furthermore, the transceiver 610 may receive communication signals, output same to a processor, and transmit signals output from the processor to a network entity through a wired/wireless network.

The memory 620 may store programs and data necessary for operations of the UE. In addition, the memory 620 may store control information or data included in signals acquired by the UE. The memory 620 may include storage media such as a ROM, a RAM, a hard disk, a CD-ROM, and a DVD, or a combination of storage media. The memory 620 may include a non-transitory computer-readable medium in which instructions executed by the processor 630 are stored. The instructions, when executed by the processor 630, may cause the UE to perform the operations set forth herein.

The processor 630 may control a series of processes so that the UE can operate according to the above-described embodiments. The processor 630 may include at least one processor. For example, the processor 630 may include a communication processor (CP) which performs control for communication and an application processor (AP) which controls upper layers such as application programs.

FIG. 7 illustrates a structure of a network entity according to an embodiment of the disclosure.

The network entity may be one of the network entities set forth herein (e.g., AAA, UPF, UDM, AUSF, SMFD, PCF, AMF, and 5G RAN UE).

As illustrated in FIG. 7, the network entity of the disclosure may include a transceiver 710, memory 720, and a processor 730. The processor 730, the transceiver 710, and the memory 720 of the network entity may operate according to the above-described communication methods of the network entity. However, the components of the network entity are not limited to the above examples. For example, the network entity may include a larger or smaller number of components than the above-described components. In addition, the processor 730, the transceiver 710, and the memory 720 may be implemented in the form of a single chip. The network entity may include network functions (NFs) such as an AMF, an SMF, a PCF, a network exposure function (NEF), a UGM, and a UPF as described above. Also, the network entity may include a base station.

The transceiver 710 refers to a network entity receiver and a network entity transmitter as a whole, and may transmit/receive signals with UEs or other network entities. The transmitted/received signals may include control information and data. To this end, the transceiver 710 may include an RF transmitter configured to up-convert and amplify the frequency of transmitted signals, an RF receiver configured to low-noise-amplify received signals and down-convert the frequency thereof, and the like. However, this is only an embodiment of the transceiver 710, and the components of the transceiver 710 are not limited to the RF transmitter and the RF receiver. The transceiver 710 may include wired/wireless transceivers, and may include various components for transmitting/receiving signals.

In addition, the transceiver 710 may receive signals through a communication channel (e.g., a radio channel), output the same to the processor 730, and transmit signals output from the processor 730 through the communication channel.

Furthermore, the transceiver 710 may receive communication signals, output same to a processor, and transmit signals output from the processor to UEs or network entities through a wired/wireless network.

The memory 720 may store programs and data necessary for operations of the network entity. In addition, the memory 720 may store control information or data included in signals acquired by the network entity. The memory 720 may include storage media such as a ROM, a RAM, a hard disk, a CD-ROM, and a DVD, or a combination of storage media. The memory 720 may include a non-transitory computer-readable medium in which instructions executed by the processor 730 are stored. The instructions, when executed by the processor 730, may cause the network entity to perform the operations set forth herein.

The processor 730 may control a series of processes so that the network entity can operate according to the above-described embodiments of the disclosure. The processor 730 may include one or more processors. Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet. Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method for wireless communication by a user equipment (UE), the method comprising:
transmitting a registration request message to an access and mobility function (AMF), wherein the registration request message comprises information indicating whether the UE has a function capable of notifying whether the UE uses pending network slice selection assistance information (NSSAI) in relation to slice authentication or slice subscription; and
receiving a registration accept message from the AMF, in response to the registration request message.

2. The method of claim 1, wherein the registration request message further comprises at least one of information indicating whether the UE supports multiple functions for a slice, information for signaling an occurrence of a change in slice information stored in the UE, and information indicating whether the UE supports a function capable of requesting, as request NSSAI from the network, slices that do not belong to the same slice subscription group.

3. The method of claim 1, wherein the registration accept message comprises at least one of a slice group list, slice group-related pending NSSAI information, mapping information between a slice group and NSSAI, information indicating whether a network supports a function related to multiple slice groups, allowed NSSAI, the pending NSSAI, information indicating recommended NSSAI and a subscribed slice group, and information indicating whether the network supports an extended slice function.

4. The method of claim 1, further comprising:
determining whether to use the pending NSSAI during a registration procedure; and
based on the determination, transmitting, to the AMF, the registration request message comprising information indicating whether the UE is to use the pending NSSAI.

5. The method of claim 1, further comprising:
receiving a configuration update command message from the AMF; and
transmitting a configuration update complete message to the AMF in response to the configuration update command message,
wherein the configuration update command message comprises at least one of a slice group list, slice group-related pending NSSAI information, mapping information between a slice group and NSSAI, information indicating whether a network supports a function related to multiple slice groups, allowed NSSAI, the pending NSSAI, information indicating recommended NSSAI and a subscribed slice group, and information indicating whether the network supports an extended slice function, and
wherein the configuration update complete message comprises information indicating whether the UE is to use the pending NSSAI.

6. The method of claim 1, further comprising:
receiving a deregistration request message from the AMF; and
transmitting a deregistration accept message to the AMF, in response to the deregistration request,
wherein the deregistration request message comprises at least one of a slice group list, slice group-related pending NSSAI information, mapping information between a slice group and NSSAI, information indicating whether a network supports a function related to multiple slice groups, allowed NSSAI, the pending NSSAI, information indicating recommended NSSAI and a subscribed slice group, and information indicating whether the network supports an extended slice function, and
wherein the deregistration accept message comprises information indicating whether the UE is to use the pending NSSAI.

7. The method of claim 1, further comprising:
receiving a downlink non-access stratum (NAS) transport message from the AMF; and
transmitting an uplink NAS transport message to the AMF,
wherein the downlink NAS transport message comprises at least one of a slice group list, slice group-related pending NSSAI information, mapping information between a slice group and NSSAI, information indicating whether a network supports a function related to multiple slice groups, allowed NSSAI, the pending NSSAI, information indicating recommended NSSAI and a subscribed slice group, and information indicating whether the network supports an extended slice function, and
wherein the uplink NAS transport message comprises information indicating whether the UE is to use the pending NSSAI.

8. A method for wireless communication by an access and mobility function (AMF), the method comprising:
receiving a registration request message from a user equipment (UE), wherein the registration request message comprises information indicating whether the UE has a function capable of notifying whether the UE uses pending network slice selection assistance information (NSSAI) in relation to slice authentication or slice subscription; and
transmitting a registration accept message to the UE, in response to the registration request message.

9. The method of claim 8, wherein the registration request message further comprises at least one of information indicating whether the UE supports multiple functions for a slice, information for signaling an occurrence of a change in slice information stored in the UE, and information indicating whether the UE supports a function capable of requesting, as request NSSAI from the network, slices that do not belong to the same slice subscription group.

10. The method of claim 8, wherein the registration accept message comprises at least one of a slice group list, slice group-related pending NSSAI information, mapping information between a slice group and NSSAI, information indicating whether a network supports a function related to multiple slice groups, allowed NSSAI, the pending NSSAI, information indicating recommended NSSAI and a subscribed slice group, and information indicating whether the network supports an extended slice function.

11. The method of claim 8, further comprising receiving, from the UE, the registration request message comprising information indicating whether the UE is to use the pending NSSAI.

12. The method of claim 8, further comprising:
transmitting a configuration update command message to the UE; and
receiving a configuration update complete message from the UE in response to the configuration update command message,
wherein the configuration update command message comprises at least one of a slice group list, slice group-related pending NSSAI information, mapping information between a slice group and NSSAI, information indicating whether a network supports a function related to multiple slice groups, allowed NSSAI, the pending NSSAI, information indicating recommended NSSAI and a subscribed slice group, and information indicating whether the network supports an extended slice function, and
wherein the configuration update complete message comprises information indicating whether the UE is to use the pending NSSAI.

13. The method of claim 8, further comprising:
transmitting a deregistration request message to the UE; and
receiving a deregistration accept message from the UE in response to the deregistration request,
wherein the deregistration request message comprises at least one of a slice group list, slice group-related pending NSSAI information, mapping information between a slice group and NSSAI, information indicating whether a network supports a function related to multiple slice groups, allowed NSSAI, the pending NSSAI, information indicating recommended NSSAI and a subscribed slice group, and information indicating whether the network supports an extended slice function, and
wherein the deregistration accept message comprises information indicating whether the UE is to use the pending NSSAI.

14. The method of claim 8, further comprising:
receiving a downlink non-access stratum (NAS) transport message from the AMF; and
transmitting an uplink NAS transport message to the AMF,
wherein the downlink NAS transport message comprises at least one of a slice group list, slice group-related pending NSSAI information, mapping information between a slice group and NSSAI, information indicating whether a network supports a function related to multiple slice groups, allowed NSSAI, the pending NSSAI, information indicating recommended NSSAI and a subscribed slice group, and information indicating whether the network supports an extended slice function, and
wherein the uplink NAS transport message comprises information indicating whether the UE is to use the pending NSSAI.

15. A user equipment (UE) for wireless communication, the UE comprising:
a transceiver; and
at least one processor connected to the transceiver,
wherein the at least one processor is configured to:
transmit a registration request message to an access and mobility function (AMF), wherein the registration request message comprises information indicating whether the UE has a function capable of notifying whether the UE uses pending network slice selection assistance information (NSSAI) in relation to slice authentication or slice subscription; and
receive a registration accept message from the AMF, in response to the registration request message.

16. The UE of claim 15, wherein the registration request message further comprises at least one of information indicating whether the UE supports multiple functions for a slice, information for signaling an occurrence of a change in slice information stored in the UE, and information indicating whether the UE supports a function capable of requesting, as request NSSAI from the network, slices that do not belong to the same slice subscription group.

17. The UE of claim 15, wherein the registration accept message comprises at least one of a slice group list, slice group-related pending NSSAI information, mapping information between a slice group and NSSAI, information indicating whether a network supports a function related to multiple slice groups, allowed NSSAI, the pending NSSAI, information indicating recommended NSSAI and a subscribed slice group, and information indicating whether the network supports an extended slice function.

18. The UE of claim 15, wherein the at least one processor is further configured to:
determine whether to use the pending NSSAI during a registration procedure; and
based on the determination, transmit, to the AMF, the registration request message comprising information indicating whether the UE is to use the pending NSSAI.

19. The UE of claim 15, wherein the at least one processor is further configured to:
receive a configuration update command message from the AMF; and
transmit a configuration update complete message to the AMF in response to the configuration update command message,
wherein the configuration update command message comprises at least one of a slice group list, slice group-related pending NSSAI information, mapping information between a slice group and NSSAI, information indicating whether a network supports a function related to multiple slice groups, allowed NSSAI, the pending NSSAI, information indicating recommended NSSAI and a subscribed slice group, and information indicating whether the network supports an extended slice function, and
wherein the configuration update complete message comprises information indicating whether the UE is to use the pending NSSAI.

20. The UE of claim 15, wherein the at least one processor is further configured to:
receive a deregistration request message from the AMF; and
transmit a deregistration accept message to the AMF, in response to the deregistration request,
wherein the deregistration request message comprises at least one of a slice group list, slice group-related pending NSSAI information, mapping information between a slice group and NSSAI, information indicating whether a network supports a function related to multiple slice groups, allowed NSSAI, the pending NSSAI, information indicating recommended NSSAI and a subscribed slice group, and information indicating whether the network supports an extended slice function, and
wherein the deregistration accept message comprises information indicating whether the UE is to use the pending NSSAI.
